(19) United States
(12) Patent Application Publication
(10) Pub. No.: US 2006/0166081 A1
(43) Pub. Date: Jul. 27, 2006

(54) Battery manifold vent

(75) Inventors: Mark E. Sauter, Shorewood, WI (US); Fred Teshinsky, Dana Point, CA (US)

Correspondence Address: FOLEY & LARDNER LLP, 777 EAST WISCONSIN AVENUE, SUITE 3800, MILWAUKEE, WI, 53202-5308, US

(73) Assignee: Tulip Corporation

(21) Appl. No.: 11/388,709

(22) Filed: Mar. 24, 2006

Related U.S. Application Data
(63) Continuation of application No. 10/752,479, filed on Jan. 6, 2004.
(60) Provisional application No. 60/438,145, filed on Jan. 6, 2003.

(51) Int. Cl. H01M 2/12

(52) U.S. Cl. 429/88; 429/86

(57) ABSTRACT

A leak resistant battery manifold vent for a battery. The battery manifold vent includes a vent housing having an interior volume, at least two cell vents, and at least one atmospheric vent. The interior volume comprises a labyrinth system, fluid collection chamber, and vent collar. The labyrinth system has at least two fluid passageways coupling the cell vents and the atmospheric vent. The passageways include more than one fluid baffle. A fluid baffle causes a constriction of the fluid passageway extends from only one of a top portion and a bottom portion of the vent housing. The passageway is coupled by a crossover vent providing fluid communication between the two passageways. A fluid collection chamber is fluidly coupled to the passageways. The chamber has at least two orthogonal dimensions which are larger than two corresponding dimensions of the passageway. A vent collar causes a constriction adjacent the cell vent.

### REFERENCE TO RELATED APPLICATION

This application is an application claiming the benefit under 35 USC 119(e) U.S. Application 60/438,145, filed Jan. 6, 2003, incorporated herein by reference in its entirety. This application is a Continuation in part of U.S. application Ser. No. 10/752,479, filed Jan. 6, 2004, incorporated herein by reference in its entirety.

### BACKGROUND

The invention relates generally to starting, lighting, and ignition (SLI) battery covers or, alternatively, storage battery covers. More particularly, the invention relates to SLI battery covers having protective resistance to leakage when a battery, having such a cover attached, is tipped to any one of its sides, is inverted, and/or pressure is provided to the sides and/or ends of the battery housing.

Conventionally, SLI batteries have a battery housing, the housing has a cover for closing an open top end of the housing. The battery housing is conventionally a rectangular casing with multiple interior partitions forming cells which are configured to house cell plates and electrolyte. The cover is conventionally heat sealed to the open top end of the battery housing. The cover may include electrical terminals extending therefrom which are electrically connected to the cell plates within the housing. The cover also includes exhaust ports or cell vents which are used to vent reaction gases from the battery cells.

The cover conventionally has a secondary cover, cap, or manifold pod vent which is assembled over the top surface of the cover and includes vent barrels which interface with the venting ports of the cover. Alternatively, the cover may be an integrated manifold vent cover in which the manifold is integrated into the cover itself and is not formed as a separate detachable manifold pod vent. Hereinafter, the use of the terminology manifold or manifold vent is intended to describe generally both a manifold pod vent or pod and a manifold cover.

Once the cell compartments have been filled with electrolyte, the manifold pod vent is secured to the cover by a press fit between the manifold pod vent barrel and the cover vent well or a heat sealing such that when reaction gases from each cell or compartment are produced, they may exit through the cavities formed within the manifold and through one or more exhaust ports formed in the manifold. The cavities formed within the manifold are conventionally used for holding and/or containing any electrolyte that may be spilled into the manifold when the battery is tipped.

During operation of the battery, heat may be produced via the electrolysis process which causes the electrolyte and water in the electrolyte to go through a phase change into a gas. Reaction gases from the cell may be produced during operation of the battery and/or may be produced from heating of the battery. Conventionally, the reaction gases are released to the atmosphere through a vent which is formed in the cover of the battery. If the battery is tipped, tilted, inverted, and/or pressurized electrolyte may be lost through the atmospheric vent and thereby require replenishing of the electrolyte in the cell compartments. In the case of mishandling of a battery during delivery, installation, and/or maintenance and/or the battery being tipped or overturned during an accident, it would be desirable to have the electrolyte of the battery contained within the battery housing and manifold such that the electrolyte does not exit the battery manifold through the atmospheric vents. The electrolyte, being typically acidic, may pose a threat to persons and property upon leakage from the housing.

A variety of devices have been developed which may prevent electrolyte from spilling or leaking from a battery when it is tipped ninety degrees to any one of its sides. Many of these arrangements may prevent leakage when the battery is not subjected to vibration or the battery is not subjected to pressure being provided to the sides of the housing. Accordingly, there is a need for a cost effective battery manifold which provides resistance to leakage of electrolyte from the battery when the battery is tipped on the side or inverted and further provides resistance to leakage of electrolyte when the battery is subjected to vibration, agitation, or limited amounts of pressure provided to the sides of the battery housing.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the aforementioned needs.

### SUMMARY

Alternative examples and other exemplary embodiments relate to other features and combination of features as may be generally recited in the claims.

What is provided is a leak resistant battery manifold vent for a battery containing fluid. The battery manifold vent comprises a vent housing having interior volume, at least two cell vents, and at least one atmospheric vent. The interior volume comprises a labyrinth system having at least two fluid passageways coupling the cell vents and the atmospheric vent, the passageways include more than one fluid baffle. The more than one fluid baffle causes a restriction of the fluid passageway and the fluid baffles extend from only one of a top portion or the bottom portion of the vent housing. The passageways are coupled by a crossover vent providing fluid communication between the two passageways. A fluid collection chamber fluidly couples the passageways. The chamber has at least two orthogonal dimensions which are larger than two corresponding dimensions of the passageway. A vent collar is adjacent to cell vent and causes a constriction adjacent to cell vent.

What is also provided is a battery containing fluid. The battery comprises a housing having at least one fluid chamber. Each fluid chamber has a fluid chamber vent. A leak resistant manifold vent is coupled to the housing. The manifold vent defines an interior volume. The interior volume is in fluid communication with at least one atmospheric vent and at least one cell vent. The cell vent is coupled to the fluid chamber vent. The leak resistant manifold comprises a cover portion and a base portion. The cover portion and the base portion are fused. The based portion has a bottom. The bottom is tapered in directions which encourage drainage of fluid toward the cell vents when the battery is in an upright position. A plurality of walls extend between the cover and the base portion. The walls form a labyrinthian passageway and a collection chamber. A plurality of baffles extend from the cover and form a plurality of constrictions in the passageways between the base portion and the baffles. The constrictions have a height.

Further, what is provided is a leak resistant battery manifold vent per battery containing fluid. The manifold vent comprises a vent housing having an interior volume. The vent housing also has at least one cell vent. The vent housing also has at least one atmospheric vent. The interior volume comprises a labyrinth system having at least one fluid passageway coupling the cell vent and the atmospheric vent. The passageway includes more than one fluid baffle. The more than one fluid baffle causes a constriction of the fluid passageway and the fluid baffles extend from only one of a top portion or a bottom portion of the vent housing. The passageway includes at least one expanded region in the passageway providing a fluid collection area within the passageway. A fluid collection chamber is fluidly coupled to the passageway. The chamber has at least two orthogonal dimensions which are larger than two corresponding dimensions of the passageway. A vent collar is adjacent the cell vent and causes a constriction adjacent to cell vent.

### BRIEF DESCRIPTION OF THE DRAWINGS

The invention will become more fully understood from the following detailed description, taken in conjunction with the accompanying drawings, wherein like reference numerals refer to like elements in which:

FIG. 1 is an exemplary exploded representation of a battery housing having a cover and a manifold for venting;

FIG. 2 is a plan view of the top part of the manifold pod vent of FIG. 1.;

FIG. 3 is a cross-section view of the top part of the manifold pod vent of FIG. 2 taken generally along lines 3-3;

FIG. 4 is a bottom part of the manifold pod vent;

FIG. 5 is a cross-section of the bottom part of the manifold pod vent of FIG. 4 taken generally along lines 5-5;

FIG. 6 is an example of a battery cover.

FIG. 7 is an assembly view of the manifold pod vent top part illustrated in FIG. 2 coupled to the bottom part illustration in FIG. 4, with the bottom part in broken lines.

FIG. 8 is a sectional view of an exemplary embodiment of the manifold pod vent illustrated in FIG. 7 along the line 8-8.

FIG. 9 is a sectional view of the manifold vent illustrated in FIG. 7 along the line 9-9.

FIG. 10 is a sectional view of the manifold vent illustrated in FIG. 7 along the line 10-10.

FIG. 11 is a plan view of an exemplary embodiment of the top part of a manifold pod vent with all the cell vents in fluid communication with a single atmospheric vent.

FIG. 12 is a plan view of the corresponding bottom part of the manifold pod vent illustrated in FIG. 11.

FIG. 13 is a cross-sectional view of the combined top and bottom parts of the manifold pod vent along the line 13-13 illustrated in FIGS. 11 and 12.

### DETAILED DESCRIPTION

An exemplary embodiment of the invention relates to a leak resistant battery manifold for SLI batteries. The battery manifold provides a labyrinth of passages or passageways that provide a path which is in communication with three (3) of the vents (or cell vents) of the housing cover to an atmospheric vent on the manifold. The labyrinth is configured in such a manner to prevent electrolyte from reaching the atmospheric vent and spilling out of the battery.

Adjacent the atmospheric vent is a frit which allows the passing of gas to and from the manifold and helps to retard the ignition of the reaction gases inside the manifold should the reaction gas exiting the manifold vent be ignited.

The passages forming the labyrinth may include channels having twists and turns in a combination of directions.

Further, the passages of the labyrinth may include portions forming reservoir regions, chambers, or collection chambers. The collection chambers are generally dimensioned having a length and width which is greater than the width of the passageways. Also, a single collection chamber may be coupled to a plurality of passageways and/or to a plurality of cell vents.

Further still, the cover may include conduit passages having a plurality of baffles or dams, (hereinafter referred to as baffles) formed periodically therein.

In one embodiment, one or more cell vents may be coupled to or in communication with a single labyrinth.

The convoluted passages and/or labyrinth may have one or more of the structures shown and described in this disclosure operate to form a fluid-lock between each cell and the atmospheric vent.

In an embodiment, the convoluted passages and/or labyrinth, having one or more of the structures shown and described in this disclosure, operate to form a fluid-lock between three cells and an atmospheric vent.

Further, the convoluted path may also be configured to provide gas pockets which become pressurized and are then able to support a pressure head.

Further still, specific structures such as the frit as well as the baffles provide constriction which prevent the free flow of gas entering and exiting the atmospheric vent.

When electrolyte enters the labyrinth, liquid may become trapped in certain areas in the labyrinth and cause a fluid-lock situation in which gas may be prevented from entering the atmospheric vent and thus electrolyte is prevented from leaving each of the battery cells and entering the labyrinth. In an alternative situation, the labyrinth may trap liquid in certain areas in the labyrinth causing a fluid-lock condition, but still enabling reaction gases to leave the manifold.

In some situations, air bubbles are trapped within the labyrinth and become pressurized to support a pressure head and likewise aid in preventing additional electrolyte from leaving the battery cells and entering the labyrinth and thereby preventing electrolyte from leaking through the atmospheric vent.

Further still, the baffles and frit provide for constrictions throughout the labyrinth passageways making it more difficult for electrolyte to flow freely through the labyrinthian passageways.

Another exemplary embodiment of the design provides a single labyrinth that is configured to communicate with two or more cell vents and into a single common passageway which fluidly communicates with an atmospheric vent. In each manifold there may be one or more of these common passageways which serve two or more cell vents.

Another exemplary embodiment may be to include sloped regions which encourage electrolytes to drain back into each cell vent. The sloped portion may be in the form of a truncated conical shaped drain such that electrolyte flowing near the drain region may be encouraged to flow back into each of the cells. Alternatively, or in connection with the conical shaped drain, sloped or tapered channels may be formed in the base of the manifold, which aids to direct electrolyte to the drain regions.

In a further exemplary embodiment, the manifold may be formed of a lower portion and an upper portion. The lower and upper portions are sealed, such as by heat sealing or other methods, to form the cover or manifold having the labyrinth system formed therein.

Yet another feature of an exemplary structure are upstanding walls surrounding each cell vent that act as baffles. Still yet another exemplary embodiment is an upstanding vent collar surrounding each cell vent and extending from the top portion of the manifold and maintaining a small amount of clearance between the vent collar and the cell vent drain region. The vent collars may include slotted areas in addition to space between it and the opposing cover portion.

In one exemplary embodiment, the vent collar is sufficiently close to the lower portion of the manifold to cause constriction and/or flow restriction of electrolyte leaving the drain region or cell. Further, the vent collars help to prevent electrolyte from leaving the cell under vibration conditions.

In one exemplary embodiment, the manifold includes two sets of three cell vents, each set of these cell vents being in fluid communication with a single labyrinth each of the two labyrinths terminating in a single, common atmospheric vent.

In yet a further exemplary embodiment, the manifold includes two sets of three cell vents, each set of three cell vents being in fluid communication with a single labyrinth each of the two labyrinths terminating in a separate atmospheric vent.

The invention includes these features and other features either alone or in combination with one or more of the other features shown and/or described.

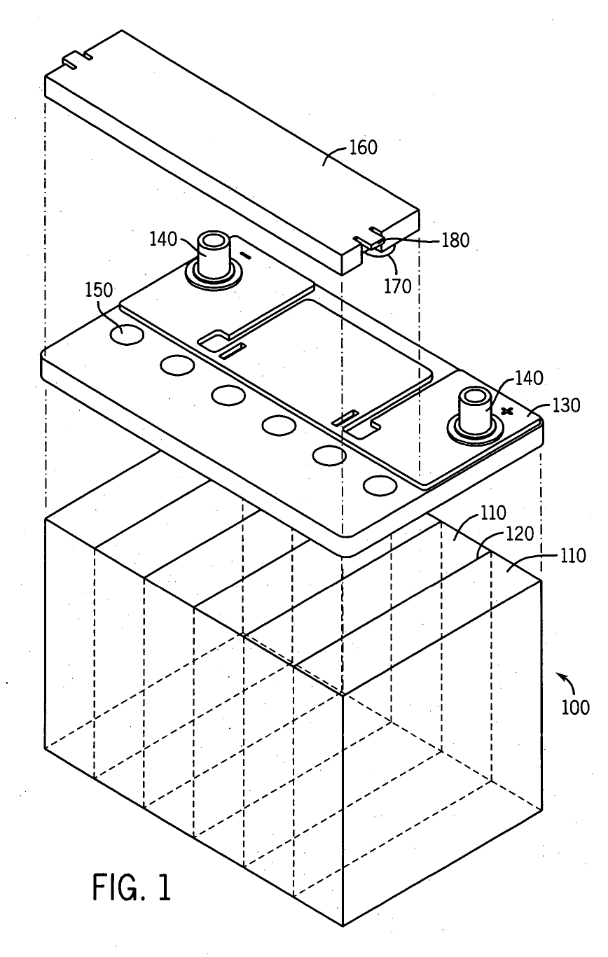

Referring to FIG. 1 an exemplary embodiment of a battery housing 100 is depicted. Battery housing 100 is conventionally formed of a polymeric material; however, other materials may be used. Battery housing 100 is partitioned into a plurality of cells 110 by a plurality of cell walls 120. Battery housing 100 also includes a battery cover 130 which is conventionally coupled to battery housing 100 via any of a number of techniques including heat sealing. Cover 130 also includes terminals 140 which are provided for electrical connection to the battery when in use. Cover 130 also includes a plurality of cell vents 150 which are formed to provide an exit for reaction gases that are produced in each of cells 110. A manifold pod vent 160 is also provided having downward protruding sections 170 which are configured to mate with venting holes 150 and are then sealed thereto by any of a variety of techniques. Sections 170 provide communication of gases through inlet apertures into manifold pod vent 160. Manifold pod vent 160 includes therein a hollowed region which has a labyrinth of passages and chambers and provide fluid communication from cell vents 150 of reaction gases through vent 180. In a preferred configuration, the labyrinth of passages and chambers prevents electrolyte which is held in each of cells 110 from escaping through vent 180 when battery 100 is tilted, tipped and/or put under certain stress, vibration, or pressure situations while allowing reaction gases from cells 110 to escape through vent 180 during normal operation and environmental conditions.

It should be noted that structures shown and described relating to the exemplary manifold pod vents may also be incorporated into structures integrated into manifold covers.

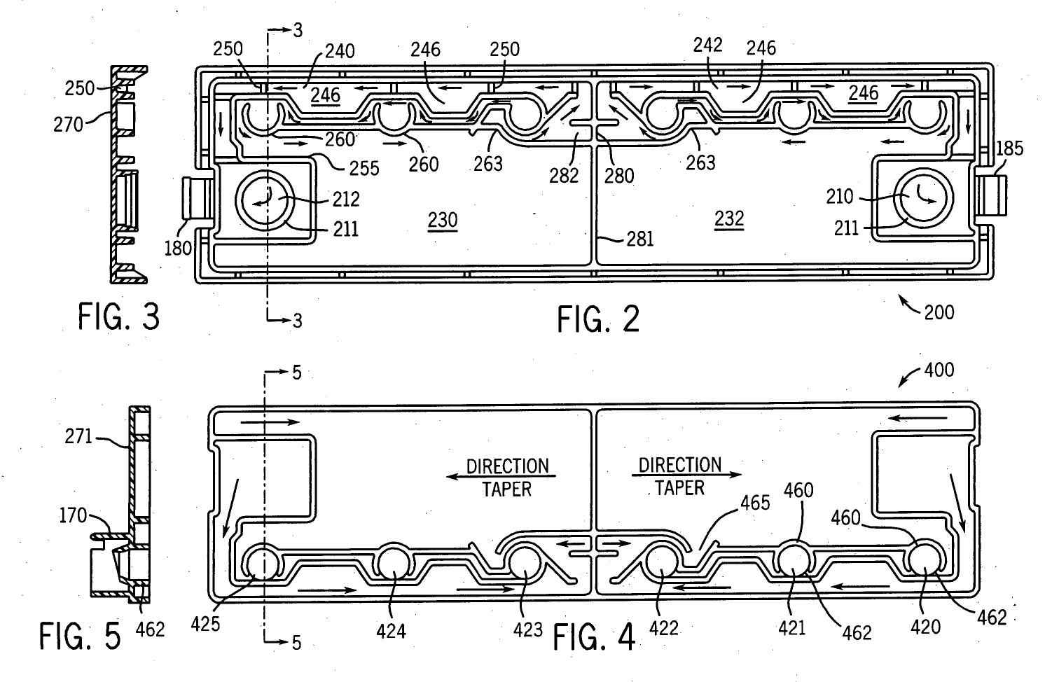

Referring now to FIG. 2, a top portion 200 of manifold pod vent 160 includes atmospheric vents 180 and 185. A bottom portion 400 of manifold pod vent 160 is depicted in FIG. 4 and comprises inlets 420-425, labyrinths that includes chambers 230 and 232 and a plurality of passages 240 and 242 to form the labyrinths. In use, bottom portion 400 and top portion 200 are fused together by any of a variety of techniques including but not limited to heat sealing, adhesive, ultrasonic welding, etc. A common pathway 242 is provided from each of inlets 420, 421 and 422 to vent 210 such that gases entering any of inlets 420, 421 and 422 will escape through atmospheric vent 185. Similarly, gases entering inlets 423, 424 or 425 have a labyrinth which includes chamber 230, vent 212 and a common pathway 240 and exiting atmospheric vent 180. In the exemplary embodiment depicted, manifold pod vent 160 comprises a crossover dam 280 which has a channel 282 which leads from the labyrinth connecting cell vents 420, 421, 422 and the labyrinth 242 connecting cell vents 423, 424, and 425. The crossover dam or baffle 280 allows both gas and liquids to flow through channel 282, although through a restriction created by baffle or dam 280. The crossover dam 280 allows for venting between the two halves of the manifold pod vent 160, the two halves being defined by wall 281 between chambers 230 and 232. Further, gas that may be stopped from venting through one vent, in the two-vent case, because of liquid in the labyrinth channel may escape through the other labyrinth channel thereby reducing the chance of bubbling or spitting gas through one of the atmospheric vents or spitting liquid through one of the atmospheric vents.

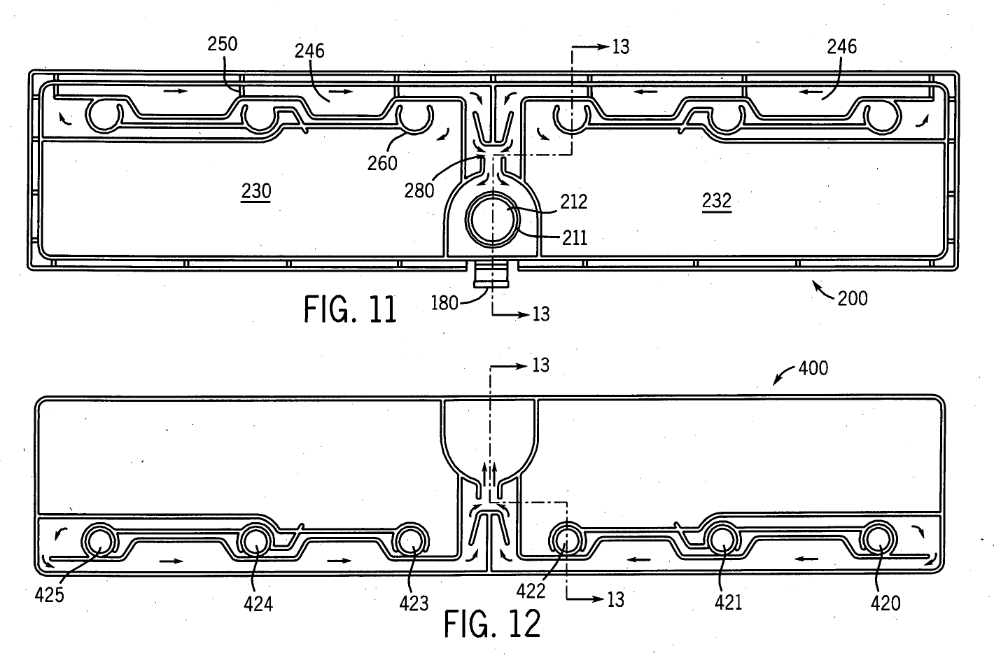

In one exemplary embodiment (see FIGS. 11, 12 and 13), only a single atmospheric vent 180 may be used thus, the crossover vent 280 allows escape of gas through the single atmospheric vent 180.

As depicted in FIG. 2, channel 282 is not in direct line with the main portion of the labyrinth path 240 and 242 thereby reducing the chance that electrolyte travels easily between the two halves.

In an exemplary embodiment, each of vents 420-425 are at least partially surrounded by a vent collar 460 extending from bottom portion 400. Similarly, top portion 200 has vent collars 260 extending down therefrom. These collars are fused together during sealing of manifold pod vent 160. However, each of these collars has an opening with a vent well rib 462 depicted in FIG. 5 which does not extend all the way to the pod vent top portion. Vent well rib 462 is located relatively close to the well opening and may help prevent acid from splashing out of the battery and into the main chamber pod during vibration. However, the opening provided by vent well rib 462 allows gas to escape into chambers 230 and 232 which then leads to labyrinths 240 and 242 that include expanded regions 246. Expanded regions 246 of labyrinths 240 and 242 allow for liquid to collect in these regions and also reduce the liquid creepage towards the vent ports and frit due to gas pressure. Because of the non-uniformity of the labyrinth channels 240 and 242, gases may still be able to escape while not pushing more liquid into vents 210 and 212.

Entrance from chamber 230 into labyrinth 240, for example and similarly from chamber 232 to labyrinth 242 are provided close to the middle cells away from the vents 180 and 185. The entrance to the reservoirs are guarded by a baffle 263. The single entrance to each labyrinth, being located near middle cells 422 and 423 may help prevent acid from getting into the labyrinthian regions during tilting of the battery. The dam 263 being at the entrance extending from the top part also helps to create an air bubble which may trap acid in the main chamber.

Bottom portion 400 has tapered regions in which the floor of portion 400 is tapered in the directions shown. This tapering aids in encouraging liquid to drain away from frit material 211 towards the vents 420-425.

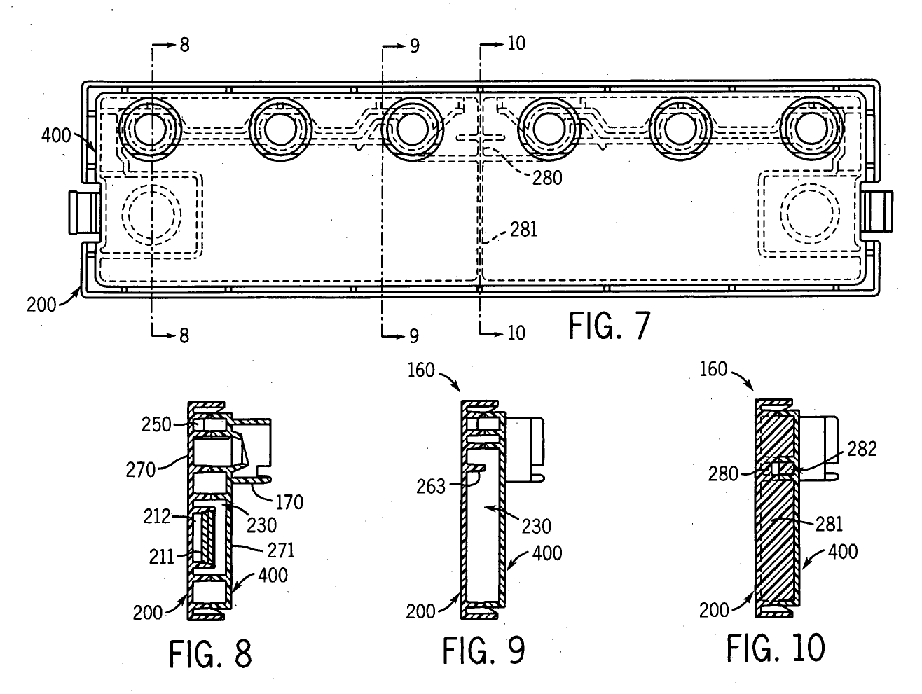

Passageway 240 includes a plurality of baffles 250 interspersed throughout the passageway 240. Baffles 250 extend partway from the top portion of the manifold 270 toward the bottom portion of the manifold 271 (see also corresponding portions in FIGS. 3, 5 and 7), the top portion and bottom portion being coupled to one another by of a variety of techniques including heat sealing such that a continuous passage remains from inlets 420, 421 and 422 to atmospheric vent 180 and passing through a frit 211. The frit area 212 may include frit material 211 of appropriate size and composition to retard a flame from igniting the gases in the pod.

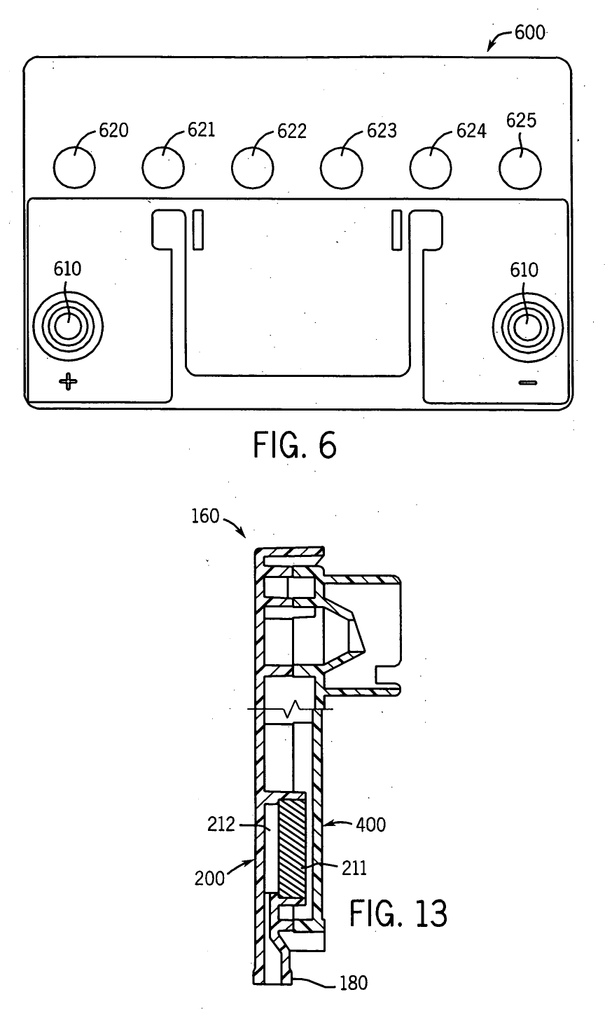

Referring now to FIG. 6, a battery cover 600 is depicted similar to the battery cover 130 of FIG. 1. Battery cover 600 includes terminals 610 for providing electrical connections to the battery and reaction gas venting apertures 620, 621, 622, 623, 624, and 625. Battery cover 600 is configured to couple with a battery housing similar to the battery housing 100 of FIG. 1 and sealed thereto by any of a variety of processes including but not limited to heat sealing and ultrasonic welding.

Referring again to FIG. 4, bottom portion of 400 of pod vent 160 is depicted. Manifold pod vent 160 is configured to be in fluid communication with reaction gas apertures or vents 620-625 via a plurality of inlets 420, 421, 422, 423, 424, and 425. Inlets 420-425 provide an inlet into the interior of manifold pod vent 160 and the labyrinth formed therein. In the exemplary bottom portion 400 depicted, inlets 420, 421, and 422 are all in fluid communication with vent 185 and inlets 423, 424, and 425 are in fluid communication with vent 180, although crossover baffle 280 and channel 282 provide communications between channels 240 and 242. Other arrangements of inlets and vents may also be provided while providing the leak resistance discussed herein.

Manifold pod vent 160 is molded in two portions and then fused together to form manifold pod vent 160. Manifold pod vent 160 includes bottom portion 400 and top portion 200. Bottom portion 400 and top portion 200 are fused by any of a variety of means including heat sealing and ultrasonic welding to form a single manifold 160. An exemplary path of travel for reaction gases to exit atmospheric vents 180 and 185 are depicted from vents 420-425 as shown by the arrows. Chambers 230 and 232 combined have an exemplary volume that is greater than one-half of the entire volume of manifold pod vent 160 cubic mm when sealed, however, other volume ratios may be used. The large size of chambers 230 and 232 are designed to help prevent electrolyte from getting into the labyrinths 240 and 242 when the battery is tilted. Further, chambers 230 and 232 may aid in creating a gas bubble to trap electrolyte in the chambers 230 and 232 when the battery is inverted. In an exemplary embodiment, the reaction gases flow under baffles 250 between vents 420-422 and a vent baffle 255. Baffles 250 extend from the top of top portion 200 but stop short of bottom portion 400 and provide a gap between baffles 250 and portion 400. The gap between baffles 250 and portion 400 is sufficient to allow the passage of gas and liquids. In an exemplary embodiment, this gap is 0.9 mm after portions 200 and 400 have been sealed.

The exemplary manifold pod vent 160 displays many of the features which provide leak resistance for the battery. Such features include, but are not necessarily limited to baffles 250, the labyrinth or serpentine path or passageway through which gas or liquid must travel to exit atmospheric vents 180 and 185, the inclusion of a chambers 230 and 232, the interconnection of multiple inlets to a single common outlet path. The unique structures and unique combination of structures found in exemplary manifold 160 work individually and collectively to provide back pressure, vacuum effects, and constriction effects when the battery is tipped, agitated, inverted, and/or put under limited amounts of pressure.

In an exemplary embodiment, the baffles in the fluid passageways may be formed in such a way, extending from the cover portion toward but not all the way to the bottom portion of the manifold vent in order to create a restriction. In an exemplary embodiment, the restriction may be 0.030 inches and may range in size up to 0.0150 inches. However, these sizes are exemplary and depending on the size of the manifold vent, other sizes for constrictions may be used. Further, the type of electrolyte or fluid within the battery may alter the applicability of the aforementioned constriction heights. Thus, the invention should not be seen as limited to the heights or proportions shown and disclosed.

In an exemplary embodiment, it may be desirable to remove any one of the aforementioned features and still provide a leak resistant manifold. For example, a leak resistant manifold may be formed without vent collars such as walls 462. Further, it may be possible to form a leak resistant manifold with less baffles or a different configuration of baffles without departing from the scope of the invention.

The design is not limited to the exact configuration of labyrinthian paths or to the exact measurements shown or further to the number of baffles, passageways, chambers, inlets, vents, etc. but is configured in such a manner as to provide leak resistance for the battery while providing an exit path for reaction gases and further for providing flame retardation of reaction gases exiting the atmospheric vents.

An exemplary leak resistant battery manifold has been described. The exemplary leak resistant battery manifold may be in the form of a manifold pod vent 160 that includes a first portion 200 and a second portion 400 forming an interior cavity therebetween. The manifold pod vent 160 also includes at least one inlet 420 and at least one atmospheric vent 180. The inlet and the atmospheric vent are in fluid communication via the cavity. The cavity is formed to include at least one wall serpentining through the cavity and forming at least one conduit. The cavity may also include a chamber 230 formed in the cavity, the chamber being in fluid communication with the inlet 420 and the atmospheric vent 180. The conduit may include at least one baffle 250 extending part way from the first portion 200 to the second portion 400.

The atmospheric vent 180 may be adjacent a frit area 212. The frit area 212 may include a wall portion extending part way from at least one of the first portion to the second portion and leaving a gap between the other of the first portion, the second portion and the wall. The frit may include a polypropylene material 211 which aids in preventing ignition of reaction gases inside the manifold and/or the battery housing if reaction gases exiting the atmospheric vent were to become ignited.

The inlet portions may include a conical and/or sloped region on the first portion which is sloped into the cell vents when coupled with the battery cover. A gap may be provided between the sloped region and a baffle portion extending from the second portion. The baffle portion may be formed into a cylinder or other shape.

The manifold may be coupled to a lead-acid battery or other type of battery having liquids therein. The manifold may also be integrally formed with the battery housing or may be assembled via processes such as heat sealing or ultrasonic welding.

The manifold may function to provide leak resistance via single functions or any combination of functions including producing air-lock, vacuum, and siphon conditions, producing and supporting of a pressure head or production of one or more pressurized gas bubbles, providing constrictions to flow throughout a pathway, and prevention of an exchange of reaction gases with atmospheric gases. The manifold may function to prevent leakage in static steady state conditions as well as under dynamic conditions. These functions act alone or in combination to prevent electrolyte from exiting the atmospheric vents in many tipped, inverted, agitated, and pressurized conditions.

While the detailed drawings, specific examples, particular structures and particular tests given describe preferred and exemplary embodiments, they serve the purpose of illustration only. The disclosure is not limited to the specific forms shown. For example, the structural configurations shown and described may differ depending on the chosen performance characteristics and physical characteristics of the battery and the manifold. For example, the structures depicted and described are not limited to the precise details, measurements, and conditions disclosed. Furthermore, other substitutions, modifications, changes, and omissions may be made in the design, operating conditions, and arrangement of the exemplary embodiments without departing from the scope of the disclosure.

What is claimed is:

1. A leak resistant battery manifold vent for a battery containing fluid, the manifold vent comprising:
a vent housing having an interior volume, at least two cell vents, and at least one atmospheric vent, the interior volume comprising:
a labyrinth system having at least two fluid passageways coupling the cell vents and the atmospheric vent, the passageways including more than one fluid baffle, the more than one fluid baffle causing a constriction of the fluid passageway and the fluid baffles extending from only one of a top portion and a bottom portion of the vent housing, the passageways being coupled by a crossover vent providing fluid communication between the two passageways;
a fluid collection chamber fluidly coupled to the passageways, the chamber having at least two orthogonal dimensions which are larger than two corresponding dimensions of the passageway; and
a vent collar adjacent the cell vent and causing a constriction adjacent the cell vent.

2. The leak resistant battery manifold of claim 1, wherein the vent housing is comprised of two pieces which are fused together.

3. The leak resistant battery manifold of claim 1, wherein the vent housing comprises six cell vents.

4. The leak resistant battery manifold of claim 1, wherein the vent housing comprises two atmospheric vents.

5. The leak resistant battery manifold of claim 1, wherein the atmospheric vent comprises a frit material.

6. The leak resistant battery manifold of claim 1, wherein the labyrinth system comprises two passageways each passageway in fluid communication with more than one cell vent and the entrance to each passageway from the chambers is nearest the middle vents.

7. The leak resistant battery manifold of claim 1, wherein the more than one baffle comprises a plurality of baffles, all of the baffles causing the same sized constriction, at least in one dimension.

8. The leak resistant battery manifold of claim 1, wherein the more than one baffle comprises a plurality of baffles, and some of the plurality of baffles are sequentially decreasing in size in one dimension causing a sequentially increased size of constriction in the dimension.

9. A battery containing fluid, the battery comprising:
a housing having at least one fluid chamber, each fluid chamber having a fluid chamber vent; and
a leak resistant manifold vent coupled to the housing, the manifold vent defining an interior volume, the interior volume in fluid communication with at least one atmospheric vent and at least one cell vent, the cell vent being coupled to the fluid chamber vent, the leak resistant manifold comprising:
a cover portion and a base portion, the cover portion and the base portion being fused, the base portion having a bottom, the bottom being tapered in directions which encourage drainage of fluid toward the cell vents when the battery is in an upright position;
a plurality of walls extending between the cover and the base portion, the walls forming a labyrinthian passageway and a collection chamber; and
a plurality of baffles extending from the cover and forming a plurality of constrictions in the passageways between the base portion and the baffles, the constrictions having a height.

10. The battery of claim 9, further comprising:
a vent collar adjacent the cell vent, the vent collar extending from the cover.

11. The battery of claim 9, wherein the housing comprises fluid chamber vents.

12. The battery of claim 9, wherein the manifold vent comprises two atmospheric vents.

13. The battery of claim 9, wherein the atmospheric vents comprise a frit material.

14. The battery of claim 9, wherein the labyrinthian passageway comprises two passageways each passageway in fluid communication with more than one cell vent and the passageways coupled by a crossover vent.

15. The battery of claim 9, wherein the plurality of baffles causes the same sized constriction height.

16. The battery of claim 9, wherein fluid collection chambers are interposed in the passageways.

17. A leak resistant battery manifold vent for a battery containing fluid, the manifold vent comprising:
a vent housing having an interior volume, at least one cell vent, and at least one atmospheric vent, the interior volume comprising:
a labyrinth system having at least one fluid passageway coupling the cell vent and the atmospheric vent, the passageway including more than one fluid baffle, the more than one fluid baffle causing a constriction of the fluid passageway and the fluid baffles extending from only one of a top portion and a bottom portion of the vent housing, the passageway including at least one expanded region in the passageway providing a fluid collection area within the passageway;
a fluid collection chamber fluidly coupled to the passageway, the chamber having at least two orthogonal dimensions which are larger than two corresponding dimensions of the passageway; and
a vent collar adjacent the cell vent and causing a constriction adjacent the cell vent.

18. The leak resistant battery manifold vent of claim 17, wherein the vent housing is comprised of two pieces which are fused together.

19. The leak resistant battery manifold vent of claim 17, wherein the expanded region of the passageway is expanded in the width dimension of the passageway.

20. The leak resistant battery manifold vent of claim 17, wherein the passageway includes a floor which is tapered in a direction which encourages drainage of liquids to the cell vents when the battery containing fluid is in an upright position.
